(19) United States
(12) Patent Application Publication
(10) Pub. No.: US 2006/0115291 A1
(43) Pub. Date: Jun. 1, 2006

(54) Electro-photographic image forming apparatus

(76) Inventor: Yoon-soo Chung, Seoul (KR)

Correspondence Address: STANZIONE & KIM, LLP, 919 18TH STREET, N.W., SUITE 440, WASHINGTON, DC, 20006, US

(21) Appl. No.: 11/251,798

(22) Filed: Oct. 18, 2005

(30) Foreign Application Priority Data
Nov. 30, 2004 (KR) 2004-99507

(51) Int. Cl. G03G 15/00; G03G 15/08

(52) U.S. Cl. 399/90; 399/119

(57) ABSTRACT

An electro-photographic image forming apparatus includes a main body provided with a first unit to perform a predetermined operation, a built-in switching mode power supply (SMPS) to rectify an input alternating current (AC) to generate a direct current (DC) to be supplied to the first unit, and first and second contact terminals formed at predetermined positions of the main body and electrically connected to the first unit and to the SMPS, respectively, and a developing unit detachably installed in the main body, and including at least one third contact terminal to electrically connect the first and second contact terminals to each other such that the DC generated by the SMPS is supplied to the first unit therethrough when the developing unit is installed in the main body. Accordingly, when the developing unit is separated from the main body, power supplied to the first unit is automatically cut off, thereby securing safety of a user.

### CROSS-REFERENCE TO RELATED APPLICATIONS

This application claims benefit under 35 U.S.C. § 119 from Korean Patent Application No. 2004-99507, filed on Nov. 30, 2004, the disclosure of which is incorporated herein in its entirety by reference.

### BACKGROUND OF THE INVENTION

1. Field of the Invention

The present general inventive concept relates to an electro-photographic image forming apparatus. More specifically, the present general inventive concept relates to an electro-photographic image forming apparatus capable of disconnecting power supplied to a high voltage power supply and a laser diode (LD) when a developing unit, which is a customer replaceable unit (CRU), is separated from the image forming apparatus.

2. Description of the Related Art

In general, an electro-photographic image forming apparatus uses an electro-photographic printing system that performs the steps of scanning a laser beam onto a photoconductive drum to form an electrostatic latent image, developing the electrostatic latent image to a visible image using a developer provided from a developing unit and transferring the image onto a printing paper, and fusing the image onto the printing paper by applying heat and pressure. The electro-photographic image forming apparatus includes laser beam printers, LED Print Heads (LPHs), copiers, and fax machines.

To apply the developer supplied from the developing unit to the photoconductive drum and to transfer the developer onto the printing paper, voltages of several hundreds to several thousands volts are applied to the photoconductive drum and the transfer unit. To this end, a High Voltage Power Supply (HVPS) generates a high voltage using power, such as +24V, supplied from a Switching Mode Power Supply (SMPS), and supplies the power to high-voltage units, such as the photoconductive drum and the transfer unit, built in the developing unit (a developing cartridge).

According to International Safety Standards, such as Underwriters Laboratories (UL), when a person comes in contact with an output voltage of a high voltage device, no current higher than 2 mA should flow through his body. This standard is equally applied to an image forming device as a recommendation for safety in case a user, having approximately 2 kΩ of the body resistance, is exposed to a high output voltage from the image forming device.

Therefore, a conventional electro-photographic image forming apparatus is equipped with a mechanical switch for shutting off the power when a user replaces the developing unit or opens a cover to remove jam or to separate the developing unit from a main body.

FIG. 1 is a schematic diagram illustrating a power shutoff device of a high voltage power supply used in a conventional electro-photographic image forming apparatus.

Referring to FIG. 1, the conventional image forming apparatus includes an SMPS 1 for generating 24V of direct current (DC) by rectifying an applied alternating current (AC) input to the SMPS 1, a HVPS 2 for generating a high voltage based on the 24V DC generated by the SMPS 1 and supplying the high voltage to a high-voltage unit, and a micro switch 3 for controlling power from the SMPS 1 to the HVPS 2 in association with opening and closing of a printer cover A. Here, the micro switch 3 is provided to one surface of the image forming apparatus in such a manner that the micro switch 3 turns off when the printer cover A is opened. Thus, when the printer cover A is opened, the micro switch 3 is turned off, thereby shutting off power flowing from the SMPS 1 to the HVPS 2.

Also, in order to prevent a laser beam which is projected from a laser diode (LD) in a laser scanning unit (LSU) from being exposed externally during the formation of an electrostatic latent image onto a photoconductive drum, power of the LD is controlled to cut off the laser beam especially when the cover of the image forming device is opened or when the developing unit is separated from the main body. This feature is important because an exposed laser beam from the LD may endanger a user's eyesight.

FIG. 2 is a schematic view illustrating a laser beam blocking structure of a conventional electro-photographic image forming apparatus.

Referring to FIG. 2, the conventional electro-photographic image forming apparatus is equipped with a shutter 11 in front of an output terminal of an LD 10 to block a laser beam emitted from the LD 10. For example, if a developing unit 12 is installed in the main body of a printer, the shutter 11 moves from a first position B to a second position C and as a result, the laser beam from the LD 10 is output externally. However, if the developing unit 12 is detached from the main body of the printer, the shutter returns from the second position C to the first position B, and the laser beam is blocked.

Besides the instrumental blocking method as described above, the micro switch operating in association with the opening and closing of the printer cover can be used to shut off the power applied from a power supply (not shown) to the LD 10.

However, both methods have disadvantages. For example, when blocking the laser beam through the instrumental structure, a designing process related to an instrument shape and a frame become very complicated and manufacture costs are increased. When using the micro switch to shut off the power supplied from the HVPS 2 to the LD 10, a contact terminal of the micro switch gets worn out or loses elasticity over time when frequently used, and the micro switch no longer functions properly.

Accordingly, a new power control system or structure is required, which is capable of shutting off power supplied from an HVPS to an LD, without employing a micro switch or a shutter.

### SUMMARY OF THE INVENTION

The present general inventive concept provides an electro-photographic image forming apparatus to secure user safety by allowing power to be supplied to a High Voltage Power Supply (HVPS) and to a laser diode (LD) only when a developing unit is installed in the image forming apparatus.

Additional aspects of the present general inventive concept will be set forth in part in the description which follows and, in part, will be obvious from the description, or may be learned by practice of the general inventive concept.

The foregoing and/or other aspects of the present general inventive concept may be achieved by providing an electro-photographic image forming apparatus, including a main body provided with a first unit to perform a predetermined operation, a built-in switching mode power supply (SMPS) to rectify an input alternating current (AC) to generate a direct current (DC) to be supplied to the first unit, and first and second contact terminals formed at predetermined positions at the main body and electrically connected to the first unit and to the SMPS, respectively, and a developing unit detachably installed in the main body and including at least one third contact terminal to electrically connect the first and second contact terminals to each other such that the DC generated by the SMPS is supplied to the first unit therethrough when the developing unit is installed in the main body.

The main body may further include a developing unit mount to mount the developing unit thereon, and the first and second contact terminals can be provided at predetermined positions of the developing unit mount to contact the at least one third contact terminal of the developing unit when the developing unit is mounted on the developing unit mount.

The first contact terminal may be electrically connected to the SMPS and the second contact terminal may be electrically connected to the first unit.

The at least one of the third contact terminals may include two third contact terminals to respectively contact the first and second contact terminals and internally connected with each other to supply the DC generated by the SMPS from the first contact terminal to the second contact terminal.

The first contact terminal and the second contact terminal may be spaced apart by a predetermined distance and may be electrically separated.

The first unit may be a high voltage power supply (HVPS) to generate a direct current of a high voltage to be applied to a predetermined high-voltage unit. The predetermined high-voltage unit may be provided in the developing unit and may include a photosensitive medium, a developer, a transfer unit, and a fusing unit.

The first unit may be a laser scanning unit (LSU) to output a laser beam.

The foregoing and/or other aspects of the present general inventive concept may also be achieved by providing an image forming apparatus, including a main body including a power supply unit to supply power and a power receiving unit electrically separated from the power supply unit, and a developing unit mountable within the main body to develop an image therein and including a connection unit to electrically connect the power supply unit to the power receiving unit when the developing unit is mounted within the main body.

The foregoing and/or other aspects of the present general inventive concept may also be achieved by providing an image forming apparatus, including a main body including a switched mode power supply (SMPS) to convert an input alternating current (AC) to a direct current (DC) having a predetermined voltage and at least one operation unit to receive the DC and to perform a predetermined operation, a developing unit detachably mounted within the main body to develop an image, and a power supply path provided between the SMPS and the at least one operation unit to transmit the DC from the SMPS to the at least one operation unit and passing through the developing unit such that when the developing unit is detached from the main body, the power supply path between the SMPS and the at least one operation unit is automatically disconnected.

The foregoing and/or other aspects of the present general inventive concept are also achieved by providing an electrophotographic image forming apparatus, including a main body, a power supply provided in the main body to supply power, an operation unit provided in the main body to operate in response to the power supplied by the power supply unit, an image forming unit provided in the main body to form an electrostatic latent image in response to the operation of the operation unit, and a developing unit mountable within the main body to develop the electrostatic latent image and including a connection unit to provide a closed circuit between the power supply unit and the operation unit when the developing unit is mounted within the main body and an open circuit when the developing unit is not mounted within the main body.

### BRIEF DESCRIPTION OF THE DRAWINGS

These and/or other aspects of the present general inventive concept will become apparent and more readily appreciated from the following description of the embodiments, taken in conjunction with the accompanying drawings of which:

FIG. 1 is a schematic diagram illustrating a structure for power shutoff of a high voltage power supply used in a conventional electro-photographic image forming apparatus;

FIG. 2 is a schematic diagram illustrating a laser beam blocking structure used in a conventional electro-photographic image forming apparatus;

FIG. 3 is a schematic diagram illustrating a structure of an electro-photographic image forming apparatus according to an embodiment of the present general inventive concept;

FIG. 4 is a block diagram illustrating a power control method of a laser diode (LD) using the structure of FIG. 3; and

FIG. 5 is a block diagram illustrating a power control method of a high voltage power supply (HVPS) using the structure of FIG. 3.

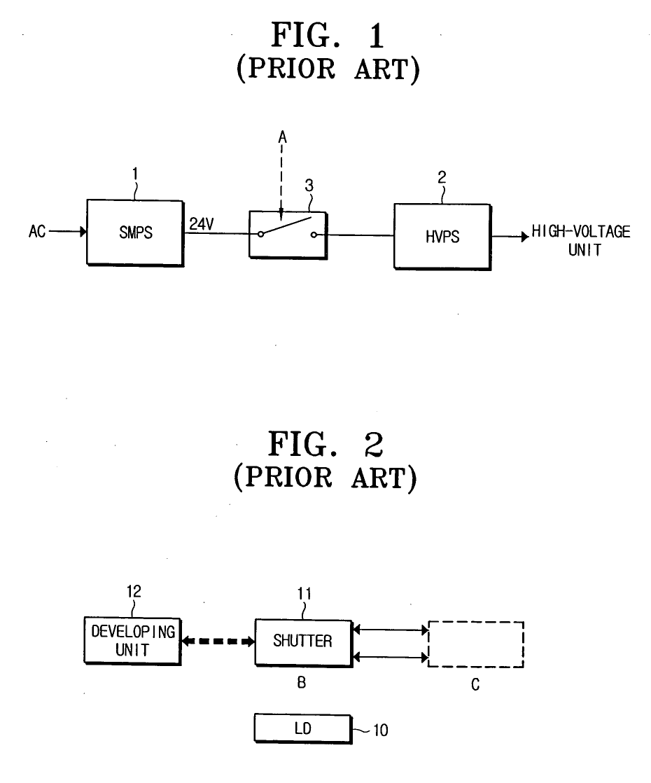

### DETAILED DESCRIPTION OF THE PREFERRED EMBODIMENTS

Reference will now be made in detail to the embodiments of the present general inventive concept, examples of which are illustrated in the accompanying drawings, wherein like reference numerals refer to the like elements throughout. The embodiments are described below in order to explain the present general inventive concept while referring to the figures.

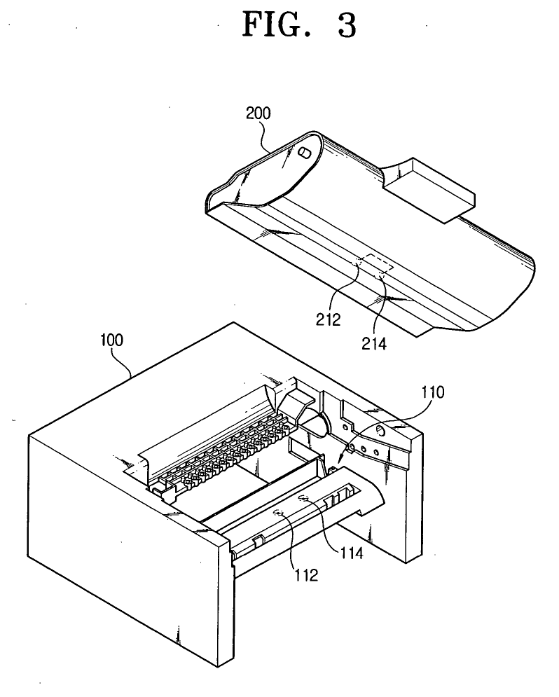

FIG. 3 is a schematic diagram illustrating a structure of an electro-photographic image forming apparatus according to an embodiment of the present general inventive concept.

Referring to FIG. 3, the electro-photographic image forming apparatus includes a main body 100, a developing unit mount 110, and a developing unit 200 detachably mountable in the main body 100 on the developing unit mount 110.

A first contact terminal 112 and a second contact terminal 114 are formed at predetermined positions of a surface of the developing unit mount 110 where the developing unit 200 is installed. A third contact terminal 212 and a fourth contact terminal 214 are formed in the developing unit 200 to contact the first contact terminal 112 and the second contact terminal 214, respectively, when the developing unit 200 is mounted on the developing unit mount 110.

As illustrated in FIG. 3, the first contact terminal 112 and the second contact terminal 114 are spaced apart by a predetermined distance and are electrically separated. The third contact terminal 212 and the fourth contact terminal 214 are also spaced apart by the predetermined distance but are electrically connected internally. That is, the third contact terminal 212 and the fourth contact terminal 214 have an internal structure that can electrically connect the first contact terminal 112 and the second contact terminal 114 when the developing unit 200 is mounted on the developing unit mount 110.

Accordingly, when the developing unit 200 is mounted on the developing unit mount 110, the first contact terminal 112 and the second contact terminal 114 having been electrically separated contact the third contact terminal 212 and the fourth contact terminal 214, respectively, and are electrically connected to each other through the third contact terminal 212 and the fourth contact terminal 214. Alternatively, the developing unit 200 can include one conductive unit to be used instead of the third and fourth contact terminals 212 and 214 to electrically connect the first and second contact terminals 112 and 114. In the following description, however, it is assumed that the developing unit includes the third and fourth contact terminals 212 and 214, as illustrated in FIG. 3.

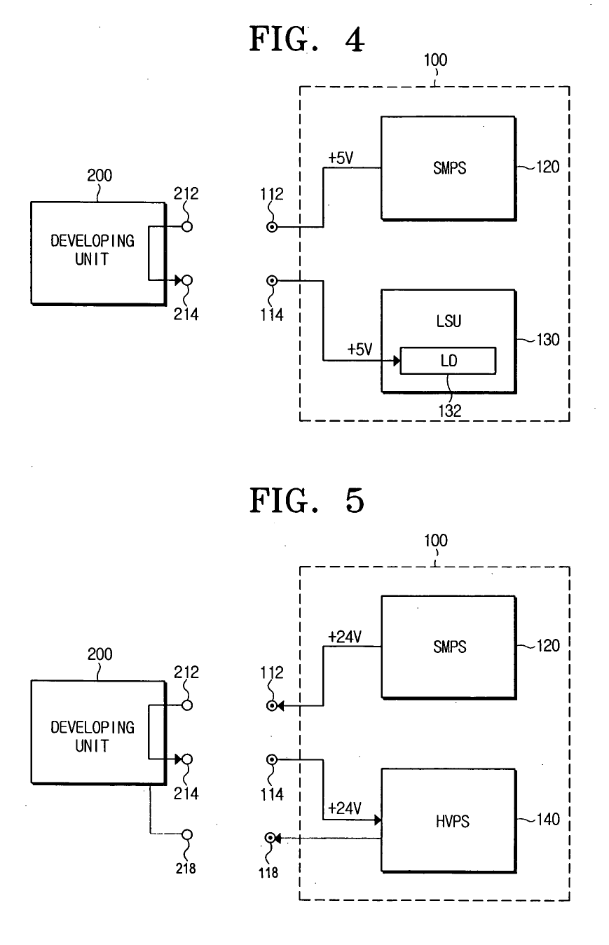

With reference to FIGS. 4 and 5, methods of controlling power supplied to a high voltage power supply (HVPS) and a Laser Diode (LD) of a Laser Scanning Unit (LSU) of the electro-photographic image forming apparatus are described below.

FIG. 4 is a block diagram illustrating a power control method of the LD using the structure of FIG. 3.

Referring to FIG. 4, the main body 100 of the image forming apparatus includes a switching mode power supply (SMPS) 120 to rectify an input alternating current (AC) to generate a 5V direct current (DC) to be supplied to an LD 132 of an LSU 130. The LD 132 of the LSU 130 receives the 5V DC from the SMPS 120 when the developing unit 200 is mounted on the developing unit mount 110 and outputs a laser beam corresponding to printing data (i.e., data to be printed).

The first contact terminal 112 of the invention is electrically connected to the SMPS 120, and the second contact terminal 114 is electrically connected to the LD 132 of to the LSU 130. The third contact terminal 212 and the fourth contact terminal 214 of the developing unit 200 are internally connected to each other. A conductive line between the third and fourth contact terminals 212 and 214 may be formed on an inside of a case of the developing unit 200 such that the conductive line is not exposed to an outside of the case.

The power control method of the LD 132 differs depending on whether the developing unit 200 is mounted on or detached from the developing unit mount 110. When the developing unit 200 is mounted on the developing unit mount 110, the 5V DC supplied from the SMPS 120 is applied to the LD 132 of the LSU 130 through the third and fourth contact terminals 212 and 214. That is, when the developing unit 200 is installed in the main body 100, the first contact terminal 112 and the second contact terminal 114 are electrically connected to each other through the third contact terminal 212 and the fourth contact terminal 214 of the developing unit 200. Accordingly, the 5V DC generated by the SMPS 120 flows into the LD 132 of the LSU 130. That is, the 5V DC from the SMPS 120 is transferred to the third contact terminal 212 through the first contact terminal 112, which is electrically connected to the SMPS 120. Then, the 5V DC flows from the third contact terminal 212 to the second contact terminal 114, which is electrically connected to the LD 132 of the LSU 130, through the fourth contact terminal 214.

In contrast, when the developing unit 200 is detached from the main body 100, the first contact terminal 112 and the second contact terminal 114 are electrically separated from each other, so the power supply from the SMPS 120 to the LD 132 is cut off. Since the power supply path from the SMPS 120 to the LD 132 is separated in the circuit, power can be supplied to the LD 132 only when the developing unit 200 is mounted on the developing unit mount 110.

FIG. 5 is a block diagram illustrating a power control method of the HVPS using the structure of FIG. 3.

Referring to FIG. 5, the main body 100 of the image forming apparatus includes an SMPS 120 to rectify an input AC to generate a 24V DC to be supplied to an HVPS 140 to receive the 24V DC from the SMPS 120 and to generate a high voltage to be supplied to a high-voltage unit (such as, a photosensitive medium, a developer, a transfer unit, and a fusing unit) provided in the developing unit 200.

The first contact terminal 112 is electrically connected to the SMPS 120, and the second contact terminal 114 is electrically connected to the HVPS 140.

The power control method of the HVPS 140 differs depending on whether the developing unit 200 is mounted on or detached from the developing unit mount 110. When the developing unit 200 is mounted on the developing unit mount 110, the 24V DC supplied from the SMPS 120 is applied to the HVPS 140 through the third and fourth contact terminals 212 and 214. That is, when the developing unit 200 is installed in the main body 100, the first contact terminal 112 and the second contact terminal 114 are electrically connected to each other through the third contact terminal 212 and the fourth contact terminal 214 of the developing unit 200. Accordingly, the 24V DC generated by the SMPS 120 flows into the HVPS 140. That is, the 24V DC from the SMPS 120 is transferred to the third contact terminal 212 through the first contact terminal 112, which is electrically connected to the SMPS 120. Then, the 24V DC flows from the third contact terminal 212 to the second contact terminal 114, which is electrically connected to the HVPS 140 through the fourth contact terminal 214.

In contrast, when the developing unit 200 is detached from the main body 100, the first contact terminal 112 and the second contact terminal 114 are electrically separated from each other, so the power supply from the SMPS 120 to the HVPS 140 is cut off.

In FIGS. 3-5 the developing unit 200 includes a developing roller supplied with a developing voltage to supply a developer to a photoconductive drum installed in the main body 100. As illustrated in FIG. 5, the developing voltage can be supplied from the HVPS 140 of the main body 100 to the developing roller through terminals 118 and 218 formed on the main body 100 and the developing unit 200, respectively. The developing voltage can alternatively be supplied from a the SMPS 120 or a separate power source other than the HVPS 140 and the SMPS 120 to be supplied through the terminals 118 and 218.

As described above, an image forming apparatus according to the present general inventive concept has a structure in which a power supply path from an SMPS to an HVPS and a power supply path from the SMPS to an LD of an LSU are electrically connected only when a developing unit is installed in a main body of the image forming apparatus. Accordingly, when the developing unit is separated from the main body of the image forming apparatus, power supplied to the HVPS and to the LD is automatically shut off, thereby securing safety of a user.

Although a few embodiments of the present general inventive concept have been shown and described, it will be appreciated by those skilled in the art that changes may be made in these embodiments without departing from the principles and spirit of the general inventive concept, the scope of which is defined in the appended claims and their equivalents.

What is claimed is:

1. An electro-photographic image forming apparatus, comprising:
a main body having a first unit to perform a predetermined operation, a built-in switching mode power supply (SMPS) to rectify an input alternating current (AC) to generate a direct current (DC) to be supplied to the first unit, and first and second contact terminals formed at predetermined positions at the main body and electrically connected to the first unit and to the SMPS, respectively; and
a developing unit detachably installed in the main body, and comprising at least one third contact terminal to electrically connect the first and second contact terminals to each other such that the DC generated by the SMPS is supplied to the first unit therethrough when the developing unit is installed in the main body.

2. The apparatus according to claim 1, wherein the main body further comprises a developing unit mount to mount the developing unit thereon, and the first and second contact terminals are provided at predetermined positions of the developing unit mount to contact the at least one third contact terminal of the developing unit when the developing unit is mounted on the developing unit mount.

3. The apparatus according to claim 1, wherein the first contact terminal is electrically connected to the SMPS, and the second contact terminal is electrically connected to the first unit.

4. The apparatus according to claim 3, wherein the at least one third contact comprises two third contact terminals to respectively contact the first and second contact terminals and internally connected with each other to supply the DC generated by the SMPS from the first contact terminal to the second contact terminal.

5. The apparatus according to claim 1, wherein the first contact terminal and the second contact terminal are spaced apart by a predetermined distance and are electrically separated.

6. The apparatus according to claim 1, wherein the first unit comprises a high voltage power supply (HVPS) to generate a direct current of a high voltage to be applied to a predetermined high-voltage unit.

7. The apparatus according to claim 6, wherein the predetermined high-voltage unit is provided in the developing unit and comprises a photosensitive medium, a developer, a transfer unit, and a fusing unit.

8. The apparatus according to claim 1, wherein the first unit comprises a laser scanning unit (LSU) to output a laser beam.

9. An image forming apparatus, comprising:
a main body including a power supply unit to supply power and a power receiving unit electrically separated from the power supply unit; and
a developing unit mountable within the main body to develop an image therein and including a connection unit to electrically connect the power supply unit to the power receiving unit when the developing unit is mounted within the main body.

10. The image forming apparatus according to claim 9, wherein the main body further includes a first connection terminal electrically connected to the power supply unit and a second connection terminal electrically connected to the power receiving unit, and the first and second connection terminals are electrically connected to each other by the connection unit when the developing unit is mounted within the main body.

11. The image forming apparatus according to claim 10, wherein the connection unit comprises:
a third connection terminal to contact the first connection terminal when the developing unit is mounted within the main body; and
a fourth connection terminal electrically connected to the third connection terminal and to contact the fourth connection terminal when the developing unit is mounted within the main body.

12. The image forming apparatus according to claim 10, wherein the connection unit comprises:
an electrically conductive material that contacts the first and second connection terminals when the developing unit is mounted within the main body.

13. The image forming apparatus according to claim 9, wherein the power supply unit comprises:
a switched mode power supply to convert an input alternating current into a direct current having a predetermined voltage.

14. The image forming apparatus according to claim 9, wherein the power receiving unit comprises at least one of a high voltage power supply to generate a high voltage signal from the power supplied by the power supply unit, and a laser scanning unit to emit a laser beam.

15. An image forming apparatus, comprising:
a main body including a switched mode power supply (SMPS) to convert an input alternating current (AC) to a direct current (DC) having a predetermined voltage and at least one operation unit to receive the DC and to perform a predetermined operation;
a developing unit detachably mounted within the main body to develop an image; and
a power supply path provided between the SMPS and the at least one operation unit to transmit the DC from the SMPS to the at least one operation unit and passing through the developing unit such that when the developing unit is detached from the main body, the power supply path between the SMPS and the at least one operation unit is disconnected.

16. The image forming apparatus according to claim 15, wherein the at least one operation unit comprises:
a high voltage power source (HVPS) to generate a high voltage signal from the DC signal and to supply the high voltage signal to the developing unit.

17. The image forming apparatus according to claim 15, wherein the at least one operation unit comprises:
a laser scanning unit to emit a laser beam.

18. The image forming apparatus according to claim 15, wherein the power supply path comprises:
first and second connection terminals electrically separated from each other, provided at predetermined portions of the main body, and electrically connected to the SMPS and the at least one operation unit, respectively; and
third and fourth connection terminals electrically connected to each other and provided at predetermined portions of the developing unit to respectively contact the first and second connection terminals when the developing unit is mounted within the main body.

19. The image forming apparatus according to claim 15, wherein the power supply path comprises:
first and second connection terminals electrically separated from each other, provided at predetermined portions of the main body, and electrically connected to the SMPS and the at least one operation unit, respectively; and
an electrically conductive member formed at a surface of the developing unit to contact the first and second connection terminals to provide a closed circuit between the the SMPS and the at least one operation unit.

20. An electrophotographic image forming apparatus, comprising:
a main body;
a power supply provided in the main body to supply power;
an operation unit provided in the main body to operate in response to the power supplied by the power supply unit;
an image forming unit provided in the main body to form an electrostatic latent image in response to the operation of the operation unit; and
a developing unit mountable within the main body to develop the electrostatic latent image and including a connection unit to provide a closed circuit between the power supply unit and the operation unit when the developing unit is mounted within the main body and an open circuit when the developing unit is not mounted within the main body.

21. The electrophotographic image forming apparatus according to claim 20, wherein the operation unit comprises:
a high voltage power supply (HVPS) to generate a high voltage and supply the high voltage to at least one of the image forming unit and the developing unit.

22. The electrophotographic image forming apparatus according to claim 20, wherein the operation unit comprises:
a laser scanning unit to emit a laser beam toward the image forming unit to form the electro static latent image.

23. A developing unit usable with an image forming apparatus having a main body formed with a first contact terminal and a second contact terminal, the developing unit comprising:
a case to contain a developing roller to supply a developer;
a third contact terminal formed on the case; and
a fourth contact terminals formed on the case, spaced apart from the third contact terminal, and electrically connected to the first contact terminal.

24. The developing unit according to claim 23, further comprising:
a conductive line formed in the case to electrically connect the third contact terminal and the fourth contact terminal.

25. The developing unit according to claim 23, wherein the fourth contact terminal is not connected to the developing roller.

26. The developing unit according to claim 23, further comprising:
a developing voltage terminal formed on the case and electrically connected to the developing roller to supply a developing voltage to the developing roller.

27. The developing unit according to claim 26, wherein the developing voltage terminal is electrically connected to one of the third and fourth contact terminals.

28. The developing unit according to claim 26, wherein the developing voltage terminal is spaced apart from the third and fourth voltage terminals.

29. The developing unit according to claim 26, wherein the developing voltage terminal is formed with one of the third and fourth contact terminals in a single body.

30. The developing unit according to claim 26, wherein the main body of the image forming apparatus comprises a power source to generate the developing voltage and the developing voltage terminal and a power supply terminal formed thereon, and the developing voltage terminal corresponds to the power supply terminal.
